(19) United States
(12) Patent Application Publication
(10) Pub. No.: US 2011/0072477 A1
(43) Pub. Date: Mar. 24, 2011

(54) USING MOBILE TERMINALS FOR TEXT ENTRY IN IPTV CHAT SESSIONS

(75) Inventors: George Foti, Dollard des Ormeaux (CA); Nilo Mitra, New York, NY (US)

(73) Assignee: TELEFONAKTIEBOLAGET L M ERICSSON (PUBL), Stockholm (SE)

(21) Appl. No.: 12/882,779

(22) Filed: Sep. 15, 2010

Related U.S. Application Data
(60) Provisional application No. 61/244,269, filed on Sep. 21, 2009.

(51) Int. Cl. H04N 7/173

(52) U.S. Cl. 725/105

(57) ABSTRACT

Systems and methods according to the exemplary embodiments provide for chat session handling in IPTV systems. A chat server can be configured to forward text messages associated with a particular chat session toward an IPTV terminal for output thereon. Chat message entry can be performed by using a wireless text entry device, e.g., a mobile phone. An IPTV control server can be configured to recognize a request for a chat session which involves output of chat messages on an IPTV terminal, and to verify that the user has a linked mobile phone and IPTV subscriptions.

### RELATED APPLICATION

The present application is related to, and claims priority from, U.S. Provisional Patent Application No. 61/244,269, filed Sep. 21, 2009, entitled “Using Mobile Terminals for Text Entry in IPTV Chat Sessions”, to George Foti and Nilo Mitra, the disclosure of which is incorporated herein by reference.

### TECHNICAL FIELD

The present invention relates generally to communications systems and in particular to methods and systems for chatting in IPTV systems.

### BACKGROUND

As technology advances, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at a home. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet, and associated communication streams, has also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services can include Internet Protocol television (IPTV, referring to systems or services that deliver television programs over a network using IP data packets), video on demand (VOD), voice-over-IP (VoIP), and other web related services.

To accommodate the new and different ways in which IP networks are being used to provide various services, new network architectures are being developed and standardized. One such development is the Internet Protocol Multimedia Subsytem (IMS). IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer.

Chatting (i.e., conversations enabled by sending text messages to others) while watching TV, and having the entered text displayed on the screen, is a likely service scenario for IPTV given, for example, the predilection of current youth for performing multiple, interactive activities simultaneously. To support such a service, one of the more difficult obstacles to overcome is the provision of a mechanism which enables the user to enter the text while watching TV. Most chatting solutions leave open the mechanism for entering text or rely on non-TV paradigms, such as using a keyboard with wireless connectivity to the TV or using a virtual keyboard which is overlaid on the TV screen on which the user navigates using up/down/left/right buttons associated with a TV remote control device.

Using a physical keyboard with a TV is unlikely to be acceptable to consumers, since this changes the normal TV watching paradigm. Moreover, even if consumers could be persuaded to adopt physical keyboard usage in the context of watching TV and chatting such a solution would be expensive due to the need to provide an interface for the physical keyboard to interact with the TV, and the additional peripheral devices associated with this solution. Moreover, the provision of a virtual keyboard overlaid (even translucently) on the TV display is distracting to the viewing experience, to say nothing of the difficulty of navigating the virtual keyboard using remote control buttons.

### SUMMARY

Exemplary embodiments describe systems and methods which provide for chat session handling in IPTV systems. A chat server can be configured to forward text messages associated with a particular chat session toward an IPTV terminal for output thereon. Chat message entry can be performed by using a wireless text entry device, e.g., a mobile phone. An IPTV control server can be configured to recognize a request for a chat session which involves output of chat messages on an IPTV terminal, and to verify that the user has a linked mobile phone and IPTV subscriptions.

According to one exemplary embodiment, a method for setting up a chat session on an IPTV terminal includes the steps of receiving, at a chat server, a request from an IPTV control server for setting up a chat session towards the IPTV terminal, obtaining, by the chat server, a contact point of the IPTV terminal, receiving, at the chat server, a text message associated with the chat session, and forwarding, by the chat server, the text message to the IPTV terminal using the contact point.

According to another exemplary embodiment, a chat server includes a processor configured to receive a request from an IPTV control server for setting up a chat session towards an IPTV terminal and further configured to obtain a contact point of the IPTV terminal, wherein, in response to receiving a text message associated with the chat session, the processor is further configured to forward the text message to the IPTV terminal using the contact point.

According to yet another exemplary embodiment, a method for setting up a chat session to an IPTV terminal includes the steps of receiving, at an IPTV control server, a chat session initiation request signal, verifying, by the IPTV control server, that a user associated with the chat session initiation request signal has a subscription which will enable output of text messages associated with the chat session on the IPTV terminal, and forwarding, by the IPTV control server, the chat session initiation request signal.

According to still another exemplary embodiment, an IPTV control server includes a processor that is configured to receive a chat session initiation request signal and to verify that a user associated with said chat session initiation request signal has a subscription which will enable output of text messages associated with the chat session on an IPTV terminal, wherein the processor is further configured to forward the chat session initiation request signal toward a chat server.

According to another exemplary embodiment, a method for setting up a chat session to an IPTV terminal includes the steps of establishing, by a chat server, a chat session between a first party using both a mobile device and an IPTV terminal and a second party, and sending, by the chat server, text entries input by the first party via the mobile device and associated with the chat session toward the IPTV terminal for display thereon.

According to another exemplary embodiment, a chat server includes a processor configured to establish a chat session between a first party using both a mobile device and an IPTV terminal and a second party, and further configured to send text entries, which are input by the first party via the mobile device and associated with the chat session, toward the IPTV terminal for display thereon.

### BRIEF DESCRIPTION OF THE DRAWINGS

The accompanying drawings illustrate exemplary embodiments, wherein:

FIG. 1 illustrates a communication system according to an exemplary embodiment;

FIG. 2 illustrates an exemplary IPTV portion of the communication system of FIG. 1 in more detail;

FIGS. 3-6 are signaling diagrams illustrating systems and methods for chat session handling according to exemplary embodiments;

FIGS. 7 and 8 are flowcharts illustrating methods for setting up chat sessions according to exemplary embodiment;

FIG. 9 is a chat or IPTV server according to an exemplary embodiment; and

FIG. 10 is a flowchart illustrating a method for setting up a chat session according to another exemplary embodiment.

### ACRONYM LIST

HSS Home Subscriber Server
IFC Initial Filter Criteria
IG IMS Gateway
IMS IP Multimedia Subsystem
IP Internet Protocol
IPTV Internet Protocol TeleVision
ITF IPTV Terminal Function
MSRP Message Session Relay Protocol
OITF Open IPTV (an IPTV standard)
PSI Public Service Identity
SIP Session Initiation Protocol
SMS Short Message Service
TV TeleVision
URI Uniform Resource Identifier
2G Second Generation (wireless networks)
3G Third Generation (wireless networks)

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

As mentioned above, exemplary embodiments discussed herein address issues associated with implementing a chatting or texting service on a television. Text entry when chatting while watching the TV should be convenient to the user, follow established patterns of usage for chatting, and minimally disturb the viewing experience. Using the mobile terminal (also called mobile phone) meets these criteria, while other alternatives impose cost and poor user experience. Network operators are uniquely positioned to take advantage of one well-known service (mobile chat) to enhance another service (IPTV) experience.

There are two requirements stated by the Open IPTV Forum (a standards body which promulgates standards in this technology area) which should be addressed by a chatting on TV system: (1) the IPTV/chatting solution should provide a mechanism for an IPTV user to establish a chat session with another IPTV user, or any other user for that matter, using the ITF (TV) display and a suitable text entry device, e.g., remote control, and (2) for chat messages destined to IPTV users, the IPTV/chatting solution should allow an IPTV user to send text messages within a chat session and have all other users in that session receive the message on their respective ITF displays. Exemplary embodiments discussed herein accomplish these objectives by, for example, enabling users to use their mobile phones (or similar texting devices) to enter text associated with a chat session, and enabling the system to intercept the entered chat session and link that chat session to a corresponding IPTV session.

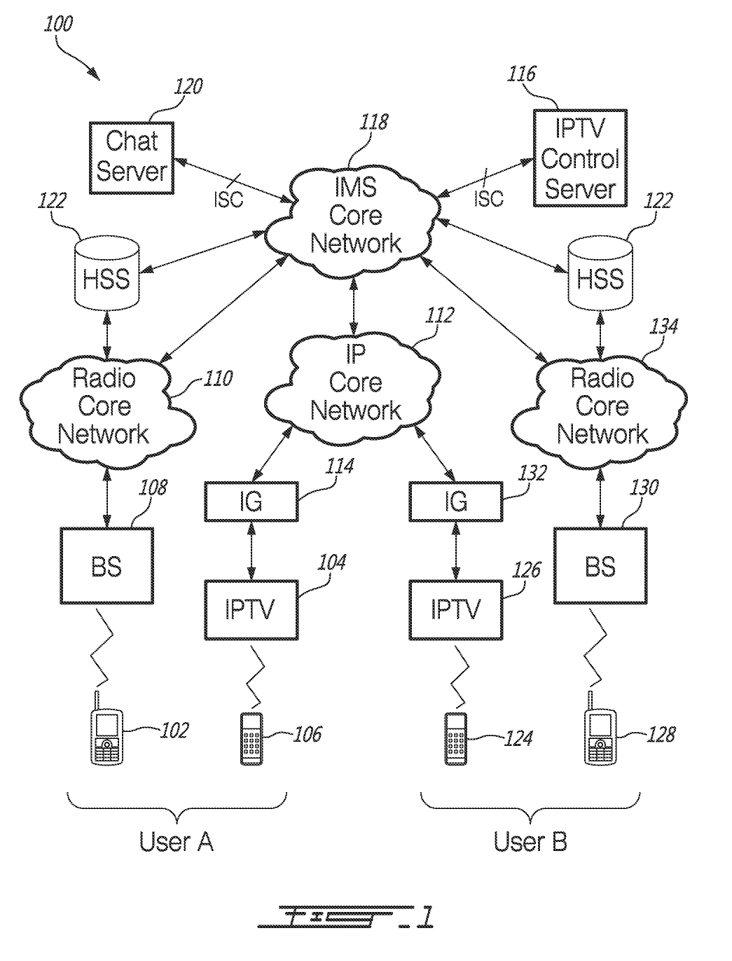

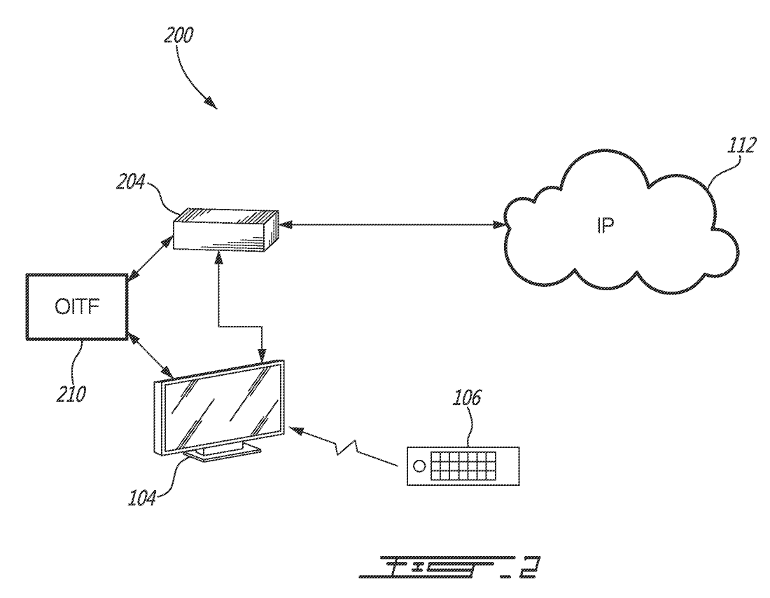

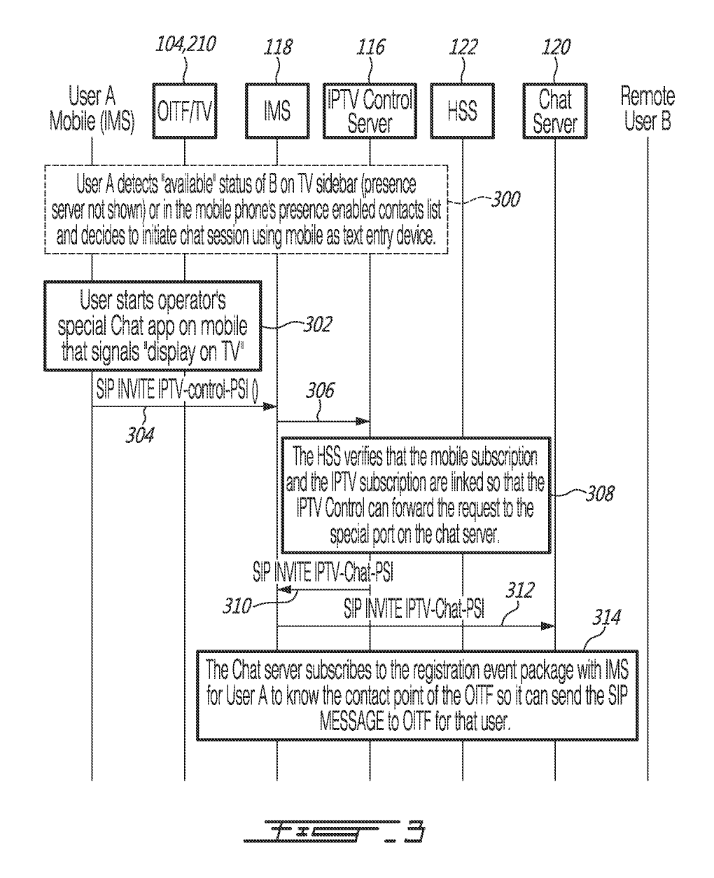

In order to provide some context for this discussion, FIG. 1 illustrates an exemplary communications network 100 in which at least some of the exemplary embodiments can be implemented. Therein, a user A is associated with a wireless texting device 102 (which can, for example, be a mobile phone and which is alternately referred to herein as a mobile phone, mobile terminal or wireless texting device) as well as an IPTV end user equipment 104. Thus user A can send commands to the IPTV 104 via a remote control device 106 as described in more detail below with respect to FIG. 2. The wireless texting device 102 communicates with a base station 108 to transfer text messages (or voice messages) to and from a radio core network 110. It will be appreciated that, in this context, the term “base station” is intended to broadly include any such access point which communicates with a wireless texting device 102 over an air interface, e.g., a repeater, a Node B, an eNodeB, etc., which will vary depending upon the radiocommunication system with which the wireless texting device is able to communicate.

The IPTV 104 is connected to an IP core network 112 via an IMS gateway (IG) and access router 114. IPTV communications between the IPTV end user equipment 104 and an IPTV control server 116 are provided via the IP core network 112, e.g., potentially including the Internet, and an IMS core network 118. A chat server 120 is also connected to the IMS core network 118 according to this exemplary embodiment, which supports chat sessions between users. One or more home subscriber servers 122 are also connected to the system and store user profile information associated with subscribers of the various services offered by the operator of the network 100. Similar components, including remote control 124, IPTV end user equipment 126, wireless texting device 128, base station 130, IG 132 and radio core network 134 are illustrated in FIG. 1 in support of user B's communications. It will be appreciated by those skilled in the art that the network 100 is purely exemplary and that other network configurations, components, etc., may be used to implement the functionality which will be described herein. For example, radio core networks 110 and 134 may be the same network and/or only one HSS 122 may be present. Moreover, user A or user B may not be using an IPTV end user equipment during the chat sessions described herein. Other variants are described below.

IPTV is a service which provides digital television signals delivered using IP over a network architecture (such as IMS) and may be combined with telephone services (such as VoIP), web access, VoD and, of particular interest in this description, chat. An exemplary user side of an IPTV system from which a combined chat service and IPTV service may be initiated according to these exemplary embodiments will now be described as shown in FIG. 2. Therein, the IPTV system 200 includes an IPTV (web TV) 104, a set-top box 204 and a connection to the IP network 112. The IPTV 104 is capable of displaying a variety of video signals, associated with different content types described below, and can also be used according to these exemplary embodiments as a display (output) for chat sessions between user A and user B. In particular IPTV 104 is capable of receiving signals using IP protocols either directly or via set-top box 204. Set-top box 204 typically acts to control inputs to IPTV 104 and is in communications with both IPTV 104 and IP network 112 (potentially through an IG 114, if not integrated therewith). IG 114 can contain a removable smart card (not shown) such as an IP multimedia services identity module (ISIM) application on a universally integrated circuit card (UICC). The UICC contains memory within which security information and applications can be stored.

In the system of FIG. 2, a remote control device 106 may, for example, communicate wirelessly (e.g., via IR or RF) to provide inputs to the IPTV 104 and/or set-top box 204. An Open ITV Terminal Function (OITF) 210, sometimes more generally referred to as an ITV Terminal Function (ITF) runs on either (or is distributed between) IPTV 104 and set-top box 204. The OITF 210, among other things, operates according to exemplary embodiments to display chat communications (text) in one or more areas of the screen of IPTV 104 as will be described in more detail below. For the interested reader, many more details regarding IPTV systems in general are described in the standard specification OIPF-T1-R2-Functional Architecture V 2.0, Sep. 8, 2009, promulgated by the Open IPTV Forum, the disclosure of which is incorporated here by reference.

Using the above-described exemplary radiocommunication, IPTV and IMS architectures shown in FIGS. 1 and 2, exemplary embodiments enable an end user A to simultaneously watch an IPTV program, enter chat messages to be sent to user B into his or her wireless texting device, and display both the entered messages and those which are received back from user B. According to one exemplary embodiment, a chat session is initiated with a mobile terminal 102 for text entry and an IPTV 104 for display. For example, consider that user A, e.g., who has a subscription for the special chat service according to this exemplary embodiment with an operator, notices the “available” presence status of a friend (user B) on his IPTV 104's presence sidebar and invites this friend to a chat session. This can be done by, for example, highlighting the friend's icon/name on the TV screen using the remote control 106, and seeing a resulting menu of options—chat, call, etc, displayed by the OITF 210.

The signal to start the chat using the IPTV 104 causes the operator's IPTV control server 116 to contact the HSS 122 to identify the user's IPTV subscription profile, through which the user A's mobile number (or other identifying/routing address, e.g., an IP address, etc.) associated with wireless text entry device 128 can be determined. Subsequently, the IPTV control server 116 contacts the chat application server 120 with the mobile numbers of the two parties. For example, the mobile number of the caller (user A) can be determined from his IPTV subscription, while the mobile number of the called party (user B) can be known as a part of the saved contact information required for presence applications. It should, however, be appreciated by those skilled in the art that the use of presence to initiate the chat session in this example is purely illustrative, and is not a required element of these exemplary embodiments. For example, as alternatives, other exemplary embodiments can employ a special chat application, provided by the user's network operator as a part of the subscription, that offers a menu allowing him or her to choose the TV screen as a display. As the user chats using the contact list on his or her mobile phone, the text is displayed on the TV screen.

Regardless of the manner in which user A identifies user B as a party with whom to establish a chat session, the chat application operating on chat server 120 sends an alerting message, e.g., “incoming chat from user A”, to user B's mobile terminal 124. On accepting this alerting message, a signal sent to user A's mobile terminal 102 causes the chat application on user A's mobile terminal to start. At the same time, a chat window appears on user A's IPTV screen 104. User A enters text via his mobile phone 102. A message with the entered text is sent from the mobile terminal 102 to the chat application server 120, via network nodes such as base station 108, radio core network 110 The chat server forwards user A's text via the IMS network to user A's OITF and IPTV screen 210/104 via the IP core network 112 such that user A's text (which was entered via user A's mobile phone 102) is also displayed on user A's IPTV 104.

The actions which occur at user B's end depend on, for example, whether user B is actively using the IPTV 126, and has this service enabled via a subscription with the same operator (if so, display message on IPTV 126), or whether user B is using his mobile terminal 128 (and not IPTV 126) when contacted by user A's chat, with the same or another operator (if so, display message on mobile terminal 128). In the same way, text entered by user B is sent via the chat application server 120 to user A's OITF/IPTV display 210/104. Additionally, it will be appreciated that the interception of a given chat session for display on the IPTVs does not preclude other chat sessions, and their corresponding messages, from being passed between users A and B via the chat application server 120 and being displayed on their respective mobile terminals 102, 128.

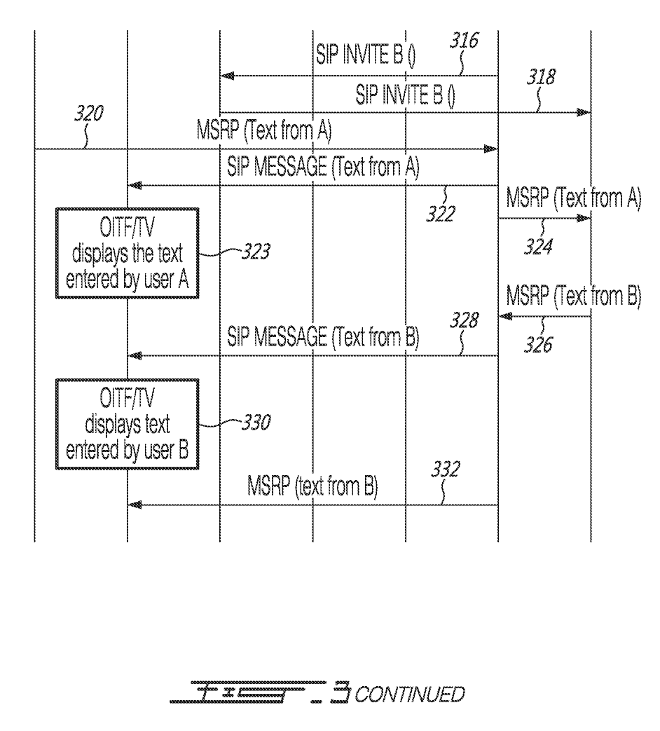

FIG. 3 is an exemplary signaling flow for implementing the above-described exemplary embodiment. It will be appreciated by those skilled in the art that not all of the steps/signals shown in this Figure are required, and that some steps/signals instead represent optional enhancements. Initially, it is assumed that the originating user A has a subscription which enables this chat service including, for this example, an IMS-based mobile subscription (3G). At step 300, user A detects the “available” status of user B on his IPTV 104's sidebar (which shows his contacts) or in his mobile phone's presence-enabled contacts list and decides to initiate a chat session using the mobile terminal 102 as his or her text entry device. At step 302, user A starts the operator's special chat application on his or her mobile phone 102. This application allows user A, through a menu configuration, to choose an option to “Use TV as display”. Note that establishing a chat session with this option selected can mean that text associated with this chat session is only displayed on the IPTV 104, or alternatively, it can mean that text associated with this chat session is displayed on the IPTV 104 in addition to one or more other output devices, e.g., mobile terminal 102. For this example, consider that user A targets user B as his or her chat partner for this chat session.

Since user A is using the special chat application provided by the operator, and he has chosen “Use TV as display” as the display option for this chat session, the request to start an IMS-based chat session (SIP INVITE) is not directed to the chat application server 120, but is instead sent to the IPTV control server 116. This is achieved by, for example, use of a special IPTV-Control Public Service Identifier (PSI) as the Request-URI of the SIP INVITE message 304 initiating the chat toward the IMS core network 118. Signal 304 is forwarded to the IPTV control server 116 as signal 306 which triggers initiation of a special chat session. The IPTV-Control PSI in signal 306 resolves to a special port on the IPTV control server 116 which hosts the application that handles this special chat application. The To field in the SIP INVITE message 306 also includes the identity of the target subscriber (user B) for the chat session.

The IPTV control server 116 uses user A's mobile number to determine user A's IPTV subscription information by contacting HSS 122 as indicated by block 308. The HSS 122 maintains, among other information, information associated with a relationship between different subscriptions belonging to the same user as a part of the operator's service offering. This relationship allows a user who has different subscriptions to use one subscription (e.g., his or her mobile phone subscription) to access the services (e.g., IPTV, Internet, etc.) on his other subscriptions (e.g., fixed telephone line subscription), and this exemplary embodiment uses this relationship information to allow the chat to be displayed on the OITF 210. The verification performed by step 308 allows the IPTV control server 116 to confirm that this IPTV subscriber is also a subscriber to the special chat application that allows for display on TV, and therefore (once this particular request is verified) the IPTV control server 116 forwards the chat session setup request to the special port on the chat server for handling this special chat session, using the special PSI dedicated for that purpose. If HSS 122 does not indicate the linked relationship between the mobile subscription and IPTV subscription exists for user A, then the IPTV control server 116 may not insert the special PSI. In such a case, the session setup request can be sent for routing to the chat server 120 and is treated like a normal chat session, i.e., having text displayed on the display of mobile phone 102.

The IPTV control server 116 sends the chat session initiation message to the chat application server 120 via signals 310 and 312. This is a special chat application which enables chat messages for a specific user to be displayed on a TV as the output device (note that the TV output device is just exemplary and any device could be used as an output device) and, as such, it is distinguished from regular chat applications which may only enable output of the chat messages on the mobile phones 102, 128. To direct the request to the proper port, a special PSI is used for that purpose, as mentioned above. The chat server 120 then subscribes to the registration event package for the originating IPTV user A to be able to receive the contact address of the OITF 210 that the user A is logged onto and currently using, which step 314 chat server 120 performs using standard IMS procedures (note that for output devices other than the TV, such a device can be configured in the user profile or information about the output device can be provided using other means, and as such exemplary step 314 could be implemented differently). Also note that the manner in which the chat server 120 obtains the contact address or contact point of the OITF 210 may vary.

The chat 120 server then forwards the message to user B (whose address is extracted from the To field in SIP INVITE message 312) via SIP INVITE messages 316 and 318. Not shown here for simplicity of the Figure, are the IMS acknowledgement messages which will be transmitted in response to receipt of the illustrated SIP invite messages. Once the chat session has been established, a chat message (MSRP) 320 from user A is sent to the special chat application in the chat server 120. The chat server 120 sends the text contained in the chat message to the OITF 210 using a SIP MESSAGE 322. The text (from user A) is displayed on user A's IPTV 104 as shown by block 323.

The chat application running on chat server 120 also forwards the chat message to user B as indicated by signal 324. In response, user B sends a chat message (MSRP) 326 which arrives at the chat application server 120. The text received by the chat server 120 in the MSRP message 326 is sent via a SIP MESSAGE 328 to the OITF/IPTV 210/104, which displays the received text. The MSRP message 326 can also be forwarded to the mobile terminal chat application operating on mobile terminal 102 so that the chat message from user B can also be displayed there in addition to displaying it on the IPTV, e.g., in keeping with the normal behavior of a mobile chat application.

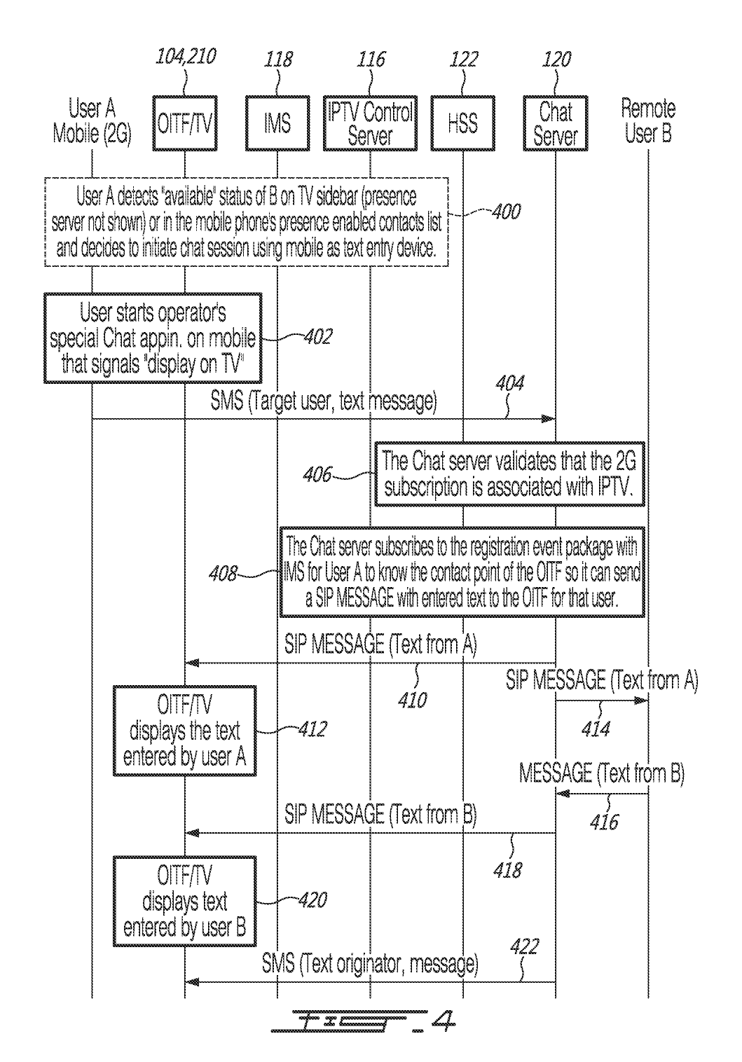

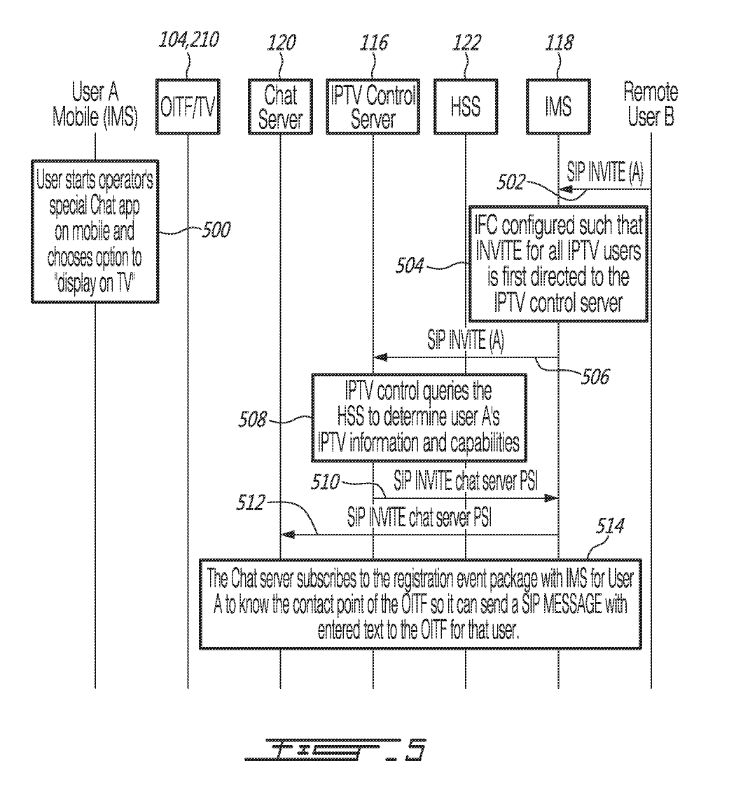

FIG. 4 shows a call flow according to an exemplary embodiment wherein the mobile terminal 102 of user A is a 2G terminal, e.g., operating in accordance with GSM, which is not IMS-capable as in the exemplary embodiment of FIG. 3. Instead, user A chats using Short Message Service (SMS). Therein, at step 400, user A detects the “available” status of user B on his IPTV 104's sidebar (which shows his contacts) or in his mobile phone's presence-enabled contacts list and decides to initiate a chat session using the mobile terminal 102 as his or her text entry device. At step 402, user A starts the operator's special chat application on his or her mobile phone 102.

User A sends a text message 404 to the target user B. This message 404 is sent to the chat server 120 as an SMS since this is within the capability of a 2G phone. The message is addressed using a special SMS code (i.e., a code which is allocated by the operator to identify the SMS message as being associated with the special chat service) so as to be received by the specialized chat application running on the chat server 120, which can then invoke the special behavior of sending any received text to the TV/OITF 104/210. This special chat application first validates that this 2G mobile subscriber (user A) is associated with an IPTV subscription (and, optionally, that user A has also subscribed to the “display chat on TV” service and determines the needed IPTV information to route the chat message toward the IPTV 104. To that effect, the chat server 120 then subscribes to the registration event package for the originating IPTV user A to be able to receive the contact address of the OITF 210 that the user A is logged onto and currently using, which step 408 chat server 120 can perform using IMS procedures.

The chat application running on chat server 120 sends the received SMS message 404 in a SIP MESSAGE 410 to user A's OITF 210 (for display there, as indicated by block 412) and in another SIP message 414 to user B. The contents of the SIP MESSAGE are displayed on user A's IPTV 104. Similarly, a message 416 received by chat server 120 from user B (e.g., in a SIP MESSAGE or in an SMS) is sent as a SIP MESSAGE 418 to user A's OITF/TV 210, 104, for display on user A's IPTV 104 as indicated by block 420. The text of the received message 416 can also be sent as an SMS message 422 to user A's mobile terminal 102 if it is desired to preserve normal chat behavior from a text messaging point of view. The special chat application running on chat server 120 maintains a threaded conversation between users A and B as shown in FIG. 4 (or FIG. 3) until the chat session is ended.

The foregoing exemplary embodiments describe cases wherein user A initiates a chat session which is to be displayed on user A's IPTV 104 (and possibly also on user A's mobile phone 102). According to another usage scenario, a chat request is instead received by user A and his or her IPTV terminal 104 is used for displaying the chat session while his or her mobile terminal is used for text entry of messages associated with that chat session. For example, consider that, while watching TV, user A (who is a subscriber to this special chat service of an operator) receives a chat message on his or her mobile terminal 102 from a friend. User A does not wish to be fully distracted from the TV screen, and so presses “display on TV” on his mobile phone 102. The chat application provided by this operator allows for this option. From that point on, the end user starts typing text via his or her mobile terminal's keyboard. The text appears on his or her TV screen, while responses from his or her friend also appear on the TV screen. The friend can be using a mobile terminal and/or using an IPTV screen to interact in the same manner.

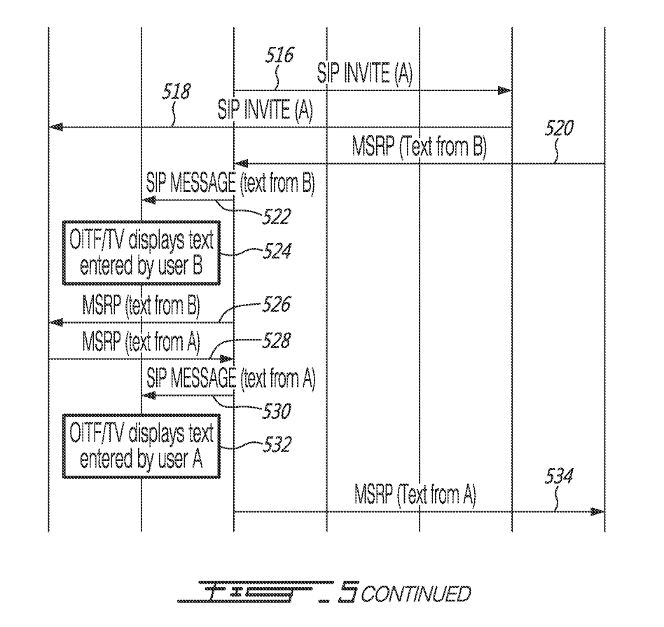

A detailed call flow diagram according to an exemplary embodiment illustrating this case, i.e., where user A is the callee rather than the caller for a chat session, is provided as FIG. 5. Therein, user A, using an IMS-capable 3G terminal 102, has his or her chat application operating on mobile phone 102 set to display incoming chat requests and messages on the IPTV 104 (albeit not necessarily only on IPTV 104, as the user may also opt to display chat messages on mobile device 106) as indicated by block 500. User B sends a chat invite message to user A via message 502 to the IMS network 118. According to this exemplary embodiment, the IMS Initial Filter Criteria (IFC) for the terminating user (user A in this example) is configured such that a SIP INVITE for a chat session destined for an IPTV user like user A is first sent to the IPTV control server 116 rather than to the chat server 120, as indicated by block 504 and SIP INVITE message 506 sent from IMS network 118 to IPTV control server 116.

The IPTV control server 116 queries. HSS 122 to determine user A's IPTV information (e.g., routing address) and capabilities, e.g., to confirm that user A has activated the “display chat to TV option”. The IPTV control server 116 then forwards the SIP INVITE message 506 with a special PSI for the chat server 120, as shown by signals 510 and 512, since this chat session employs special chat behavior and should thus be directed to the port on the chat server 120 associated with the special chat application which implements display on TV functionality, e.g., redirecting subsequent chat messages received from user B (and associated with this chat session) to the IPTV/OITF 104/210 of user A, according to these exemplary embodiments.

The chat server 120 then subscribes (block 514) to the registration event package for the originating subscriber A to be able to receive the contact address of the OITF 210 at which the user A is logged on and currently using a corresponding IPTV 104. The SIP INVITE signal 516 inviting user A to the chat session is then sent to the chat server 120 and then onto user A's mobile phone 102 via signal 518. When the user A accepts this chat invitation, e.g., using the “display on TV” option, appropriate acknowledgements are returned along the message path (not shown in the figure for simplicity).

A chat message 520 from user B to user A is sent to the chat server 120. The chat server 120 sends the text contained in the chat (MSRP) message in a SIP MESSAGE 522 to user A's OITF/TV 210/104, where it is displayed as indicated by block 524. The MSRP message can also be sent to user A's mobile phone 102 via the chat server 120, as shown by signal 526. Similarly any chat message from user A's mobile terminal 120 is sent to the chat server, an example of which is shown as signal 528. The chat server 120 sends a SIP MESSAGE 530 containing the text in the chat message body of message 528 to user A's OITF/TV 210/104 so that user A can see the text he has typed as indicated by block 532. The chat message itself is sent to user B via the chat server as signal 534.

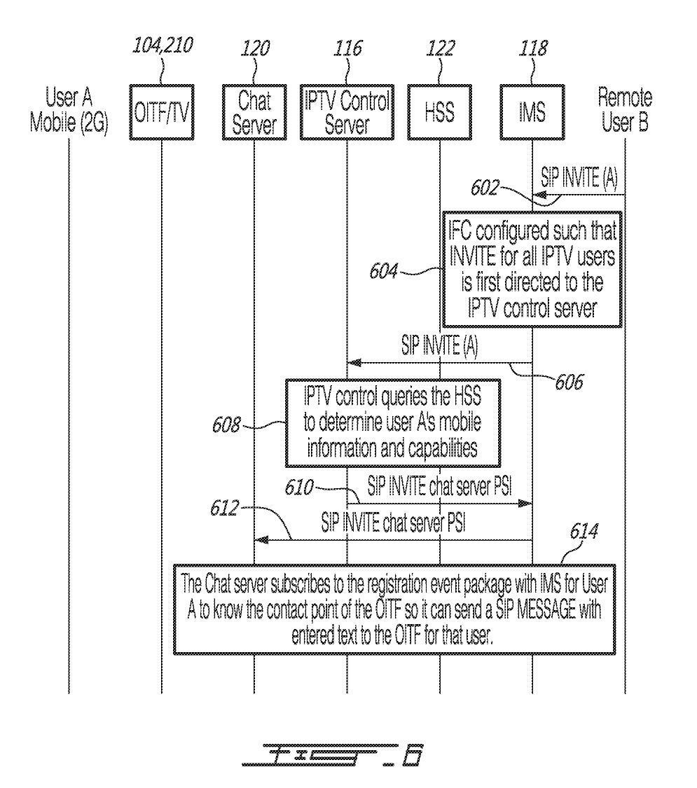

FIG. 6 shows another exemplary embodiment describing the same scenario as in FIG. 5, but where user A has a 2G phone 102. The 2G terminal 102 is not IMS-capable, and thus user A chats using SMS. Therein, steps/signals 602-614 are the same or similar to corresponding steps/signals 502-514 and, accordingly, are not re-described herein. It will be noted that there is no equivalent to the steps/signals 516 and 518 of FIG. 5 in FIG. 6 because user A has a 2G phone. Instead, the chat server terminates the IMS session and maintains its state at step 614.

Signal 616 represents a text message being received by chat server 120 from user B which is associated with the chat session setup by steps/signals 602-614. By way of message 618, this chat message is sent as a SMS to user A's mobile phone 102, where the receipt of this message triggers the opening of the special chat application on user A's mobile phone 10 as shown by block 620. If and when user A selects the “Display on TV” option, this triggers a SMS message being sent to a special SMS code corresponding to the chat application handling such requests, as shown by signal 622. When this option is selected and the corresponding signal 622 is received, the chat application running on chat server 120 sends the received text in a SIP MESSAGE 624 to user A's OITF 210, and the text message is then displayed on user A's IPTV 104 as indicated by block 626.

Signal 628 represents a responsive chat message being sent using SMS delivery. The chat server 120 converts this message 628 into a MSRP message for user B which is transmitted as signal 630. The chat server 120 also sends user A's responsive text message to user A's OITF/TV 210/104, via signal 632, where it is displayed in the portion of the screen designated for this chat session as indicated by block 634. It will also be appreciated by those skilled in the art the sequence of FIG. 6 could have been used, with minor modifications, for an instant message received from user B. There is no session setup in instant message, as opposed to chat messaging, so the SIP INVITE in the earlier steps would in this case be replaced by a SIP MESSAGE. It will be appreciated by those skilled in the art that some steps could be eliminated from, or modified in, the exemplary embodiment of FIG. 6. For example user A may pre-configure in the chat server 120 automatic activation for TV display for all incoming chat sessions, in which case steps 620 and 622 would not be required.

From the foregoing, it will be apparent to those skilled in the art that the exemplary embodiments take advantage of, for example, the ability of an operator to tie together a mobile phone subscription of a user to his IPTV subscription, thereby allowing a direct linkage of the chat activity on the mobile phone with the IPTV service currently being consumed. The operator's special chat application has the added feature to “display chat on TV”. The party that wishes to chat using the mobile phone as an input device and the TV screen as the display will typically be a subscriber of this special chat service provided by an operator, while the other parties in the chat may or may not subscribe to this special chat service.

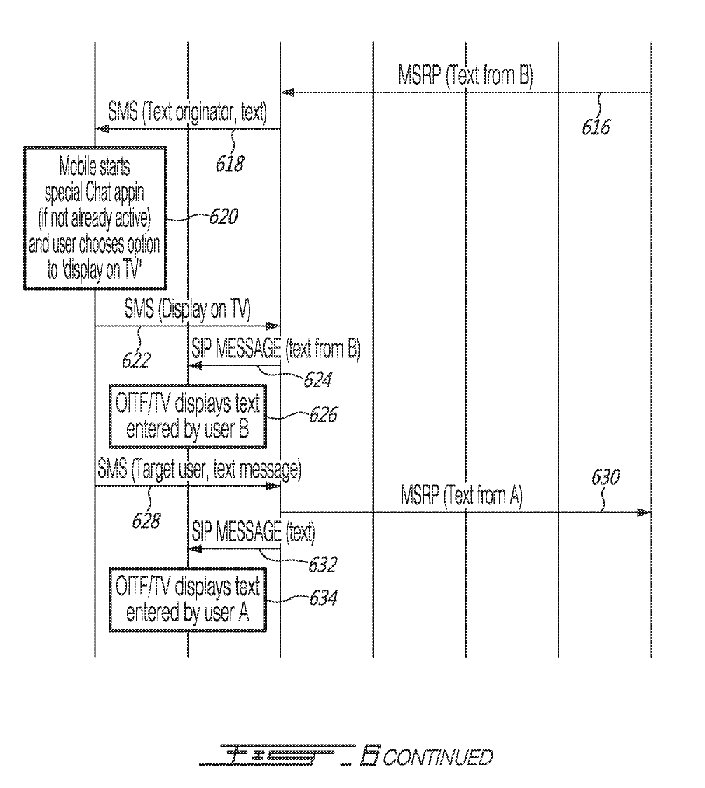

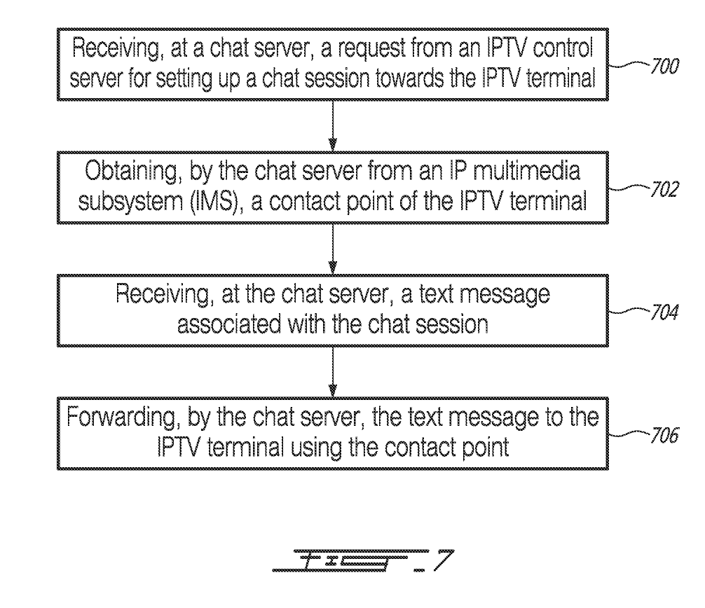

Based on the foregoing, a method for setting up a chat session to an IPTV terminal according to an exemplary embodiment can include, for example, the steps illustrated in the flow chart of FIG. 7. Therein, at step 700, a request from an IPTV control server for setting up a chat session towards the IPTV terminal is received by a chat server. The chat server obtains, at step 702 from an IP multimedia subsystem (IMS), a contact point of the IPTV terminal. A text message associated with the chat session is received by the chat server at step 704. The chat server forwards the text message to the IPTV terminal using the contact point at step 706.

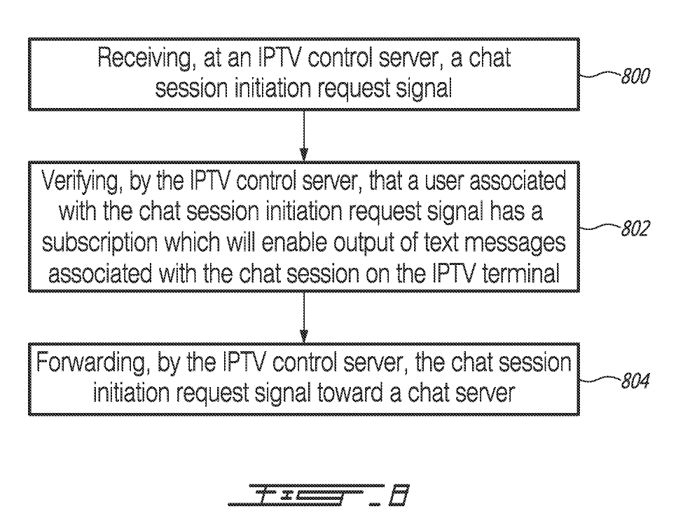

Another method for setting up a chat session to an IPTV terminal is illustrated in the flow diagram of FIG. 8. Therein, at step 800, an IPTV control server receives a chat session initiation request signal. The IPTV control server, at step 802, verifies that a user associated with the chat session initiation request signal has a subscription which will enable output of text messages associated with the chat session on the IPTV terminal. The IPTV control server forwards the chat session initiation request signal toward a chat server at step 804.

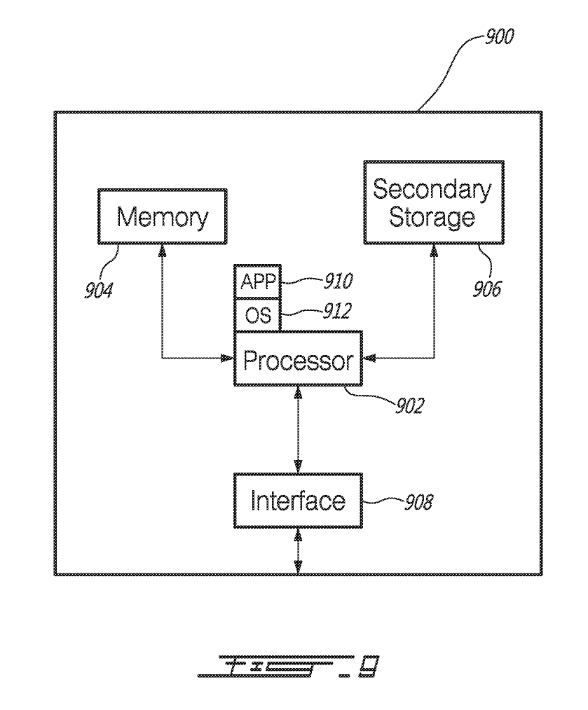

The exemplary embodiments described above provide for messages and protocols involving chat servers, IPTV servers and other network nodes. An exemplary chat or IPTV control server 900 will now be described with respect to FIG. 9. Therein, chat or IPTV control server 900 can contain a processor 902 (or multiple processor cores), memory 904, one or more secondary storage devices 906 and an interface unit 908 to facilitate communications between chat or IPTV control server 900 and the rest of the network. The processor 902 can run, for example, an operating system 910 and an application 912, e.g., a chat application or an IPTV Control/FE application, thereon and can be configured to perform the steps described in FIG. 7 or 8 above. Similar server structures can also be used for other network nodes described above, e.g., the IMS core network entities.

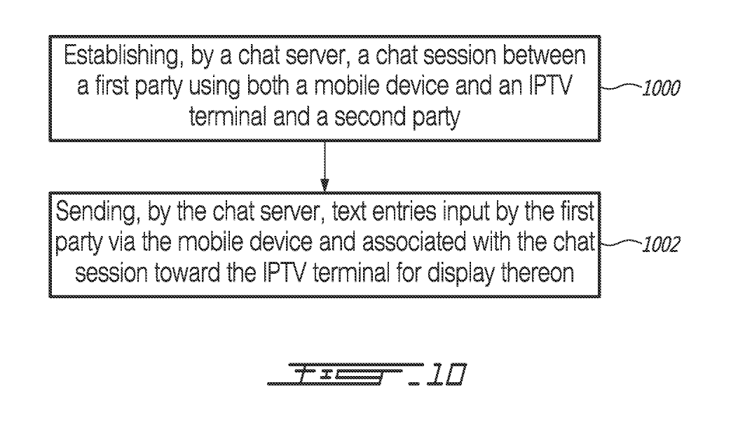

According to another exemplary embodiment, a method for setting up a chat session to an IPTV terminal includes the steps shown in FIG. 10. Therein, at step 1000, a chat session is established by a chat server between a first party using both a mobile device and an IPTV terminal and a second party. The chat server sends, at step 1002, text entries, input by the first party via the mobile device and associated with the chat session, toward the IPTV terminal for display thereon

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for setting up a chat session to an IPTV terminal comprising:
establishing, by a chat server, a chat session between a first party using both a mobile device and an IPTV terminal and a second party; and
sending, by said chat server, text entries input by said first party via said mobile device and associated with said chat session toward said IPTV terminal for display thereon.

2. The method of claim 1, further comprising:
sending, by said chat server, text entries input by said second party and associated with said chat session toward said IPTV terminal for display thereon.

3. The method of claim 2, further comprising:
sending, by said chat server, said text entries input by said second party and associated with said chat session toward said mobile device for display thereon.

4. A method for setting up a chat session to an IPTV terminal comprising:
receiving, at a chat server, a request from an IPTV control server for setting up a chat session towards the IPTV terminal;
obtaining, by said chat server, a contact point of the IPTV terminal;
receiving, at said chat server, a text message associated with said chat session; and
forwarding, by said chat server, the text message to the IPTV terminal using the contact point.

5. The method of claim 4, wherein said step of receiving further comprises:
receiving, as said request, a SIP INVITE message containing a public service identity (PSI) having a value which indicates that text messages received from a user for said chat session are to be forwarded to said IPTV terminal for display thereon.

6. The method of claim 4, wherein said step of obtaining further comprises:
subscribing to an IMS registration event package to obtain said contact point.

7. The method of claim 4, wherein said text message is generated by entry of said text message into a mobile device associated with a user of said IPTV terminal.

8. The method of claim 4, wherein said text message is generated by entry of said text into a device associated with a different user than a user of said IPTV terminal.

9. The method of claim 4, further comprising:
forwarding, by said chat server, said text message to a wireless text entry device.

10. The method of claim 4, further comprising:
running, on said chat server, a first chat application which forwards text messages only towards wireless text entry devices for output thereon; and
running, on said chat server, a second chat application which forwards text messages towards IPTV terminals for output thereon.

11. The method of claim 4, wherein said step of receiving, at said chat server, said text message associated with said chat session, further comprises:
receiving, by said chat server as said text message, a text message input via a wireless text entry device associated with one party to said chat session;
and wherein said step of forwarding, by said chat server the text message to the IPTV terminal, further comprises:
forwarding said text message to said IPTV terminal for display thereon, which IPTV terminal is also associated with said one party which input said text message via said wireless text entry device.

12. A chat server comprising:
a processor configured to receive a request from an IPTV control server for setting up a chat session towards an IPTV terminal and further configured to obtain a contact point of the IPTV terminal,
wherein, in response to receiving a text message associated with said chat session, said processor is further configured to forward said text message to said IPTV terminal using the contact point.

13. The chat server of claim 12, wherein said request is a SIP INVITE message containing a public service identity (PSI) having a value which indicates that text messages received from a user for said chat session are to be forwarded to said IPTV terminal for display thereon.

14. The chat server of claim 12, wherein said processor is configured to obtain said contact point by subscribing to an IMS registration event package.

15. The chat server of claim 12, wherein said text message is generated by entry of said text message into a mobile device associated with a user of said IPTV terminal.

16. The chat server of claim 12, wherein said text message is generated by entry of said text into a device associated with a different user than a user of said IPTV terminal.

17. The chat server of claim 12, wherein said processor is further configured to forward said text message to a wireless text entry device.

18. The chat server of claim 12, wherein said processor is configured to run a first chat application which forwards text messages only towards wireless text entry devices for output thereon and is also configured to run a second chat application which forwards text messages towards IPTV terminals for output thereon.

19. The chat server of claim 12, wherein said processor is further configured to receive said text message input via a wireless text entry device associated with one party to said chat session, and is further configured to forward said text message to said IPTV terminal for display thereon, which IPTV terminal is also associated with said one party which input said text message via said wireless text entry device.

20. A method for setting up a chat session to an IPTV terminal comprising:
receiving, at an IPTV control server, a chat session initiation request signal;
verifying, by said IPTV control server, that a user associated with said chat session initiation request signal, has a subscription which will enable output of text messages associated with said chat session on said IPTV terminal; and
forwarding, by said IPTV control server, said chat session initiation request signal toward a chat server.

21. The method of claim 20, wherein said chat session initiation signal is generated by a chat application on said user's mobile terminal which includes a public service identity (PSI) in said chat initiation request signal which informs said IPTV control server that said user requests said text messages to be output on said IPTV terminal.

22. The method of claim 20, wherein said chat session initiation signal is generated by an initial filter criteria (IFC) in an IP multimedia subsystem (IMS) which directs chat session requests associated with IPTV users to said IPTV control server.

23. The method of claim 20, wherein said step of verifying further comprises:
querying a home subscriber system (HSS) to determine whether said user has a mobile subscription which is linked to an IPTV subscription.

24. The method of claim 20, wherein said step of forwarding further comprises:
forwarding, by said IPTV control server, said chat session initiation request signal toward a port on said chat server, which port is associated with a chat application configured to enable output of said text messages on said IPTV terminal.

25. An IPTV control server comprising:
a processor configured to receive a chat session initiation request signal and to verify that a user associated with said chat session initiation request signal has a subscription which will enable output of text messages associated with said chat session on an IPTV terminal, and
wherein said processor is further configured to forward said chat session initiation request signal toward a chat server.

26. The IPTV control server of claim 25, wherein said chat session initiation signal is generated by a chat application on said user's mobile terminal which includes a public service identity (PSI) in said chat initiation request signal that informs said IPTV control server that said user requests said text messages to be output on said IPTV terminal.

27. The IPTV control server of claim 25, wherein said chat session initiation signal is generated by an initial filter criteria (IFC) in an IP multimedia subsystem (IMS) which directs chat session requests associated with IPTV users to said IPTV control server.

28. The IPTV control server of claim 25, wherein said processor is further configured to verify said user by querying a home subscriber system (HSS) to determine whether said user has a mobile subscription which is linked to an IPTV subscription.

29. The IPTV control server of claim 25, wherein said processor is configured to forward said chat session initiation request signal toward a port on said chat server, which port is associated with a chat application configured to enable output of said text messages on said IPTV terminal.

30. A chat server comprising:
a processor configured to establish a chat session between a first party using both a mobile device and an IPTV terminal and a second party, and further configured to send text entries, which are input by said first party via said mobile device and associated with said chat session, toward said IPTV terminal for display thereon.

31. The chat server of claim 30, wherein said processor is further configured to send text entries input by said second party and associated with said chat session toward said IPTV terminal for display thereon.

32. The chat server of claim 31, wherein said processor is further configured to send said text entries input by said second party and associated with said chat session toward said mobile device for display thereon.

33. The chat server of claim 30, further comprising:
at least one port associated with a special chat application which receives said text entries for routing toward said IPTV terminal.
